(19) United States
(12) Patent Application Publication
(10) Pub. No.: US 2002/0111939 A1
(43) Pub. Date: Aug. 15, 2002

(54) Image data retrieval apparatus and method capable of facilitating retrieval of desired image data from image database

(76) Inventors: Takashi Kondo, Sakai-shi (JP); Kyoko Nakamura, Toyonaka-shi (JP)

Correspondence Address: MORRISON & FOERSTER LLP, 2000 PENNSYLVANIA AVE, NW, SUITE 5500, WASHINGTON, DC, 20006-1888, US

(21) Appl. No.: 10/040,379

(22) Filed: Jan. 9, 2002

(30) Foreign Application Priority Data
Jan. 12, 2001 (JP) 2001-005243(P)

(51) Int. Cl. G06F 7/00

(52) U.S. Cl. 707/1

(57) ABSTRACT

In an image data retrieval apparatus when images stored in an image database are listed and displayed in a listing window or an image search is conducted and as a result an image of interest is displayed in a search result window the user double-clicks an image including a desired figure therein. In response the double-clicked image is enlarged and thus displayed. When the user places a mouse pointer at the position of the face of the figure in the image and then drags the mouse pointer a pixel therearound is analyzed and a face image is cut out. The face image cut out is dragged to the position of a key face entry frame and dropped therein, and thus serves as a retrieval key. Thus a retrieval key image can readily be designated. Consequently, appropriately designating an image serving as a retrieval key can alleviate the user's data entry operation and thus provide an image data retrieval apparatus improved in usability.

This application is based on application No. 2001-5243 filed in Japan, the content of which is hereby incorporated by reference.

### BACKGROUND OF THE INVENTION

1. Field of the Invention

The present invention relates generally to image data retrieval apparatuses, image data retrieval programs, and particularly to those using an object image as a retrieval key to facilitate retrieval of desired image data.

2. Description of the Related Art

It is not easy to retrieve a desired image in a digital camera having a large number of taken images stored therein. As such, typically, image database software for image management is often used to retrieve an image desired by the user.

If such conventional image database software is used, however, the user is required to input a keyword necessary for retrieval previously when image data is registered, which is a rather time-consuming and cumbersome operation.

Furthermore for retrieval the user is also required to appropriately input a keyword registered that corresponds to a desired image and for example if the user erroneously inputs the keyword or cannot remember it the user can fail to retrieve the desired image.

Accordingly it has also been proposed that rather than a keyword, an object image serving as a retrieval key is input to retrieve a desired image. However, there has not been any disclosure of any specific technique used to input an object image serving as a retrieval key.

### SUMMARY OF THE INVENTION

Therefore one object of the present invention is to provide an image data retrieval apparatus alleviating a user input operation and improved in usability.

Still another object of the present invention is to provide an image data retrieval program alleviating a user input operation and improved in usability.

The above objects of the present invention are achieved by the image data retrieval apparatus that includes the following components. More specifically the present invention provides an image data retrieval apparatus for retrieving desired image data from an image database having a plurality of items of image data registered therein, including: an extractor for extracting an image of a predetermined region from the image data registered in the image database; a retrieval key image designator for designating the extracted image as an image serving as a retrieval key; and a retriever for using the retrieval key image to retrieve from the image database image data containing an image identical or analogous to the retrieval key image.

From image data registered in an image database an image of a predetermined region included in the image data is extracted and designated as a retrieval key. Thus the retrieval key can readily be designated and an input operation can thus be less cumbersome. The designated retrieval key image is used to extract from the image database image data including an image analogous (as well as identical) to the retrieval key image. Since the retrieval key image is used to retrieve data from the image database, inputting a keyword or any other similar operation is no longer be an essential operation and the apparatus can thus be improved in usability.

Thus, appropriately extracting an image of a predetermined region serving as a retrieval key can alleviate the user's input operation and provide the apparatus with excellent usability.

Preferably, the image of the predetermined region is a face image. A face image serving as a retrieval key image allows appropriate retrieval of image data including a desired face image.

The present invention in still another aspect provides an image data retrieval apparatus for retrieving desired image data from an image database having a plurality of items of image data registered therein, including; a retrieval key image extractor for extracting images serving as a retrieval key for search through the plurality of items of image data registered in the image database; a storage for storing the extracted retrieval key images therein; a retrieval key image designator for designating a desired retrieval key image among the stored retrieval key images; and a retriever for using the designated retrieval key image to retrieve from the image database more than one item of image data containing an image identical or analogous to the retrieval key image.

In order to retrieve image data more than one images are extracted to serve as a retrieve key and among the extracted retrieval key images a desired retrieval key image is extracted and used to retrieve from the image database image data including an image identical or analogous to the retrieval key image. Allowing a desired key retrieval image to be designated among multiple retrieval key images can improve the apparatus in usability.

The present invention in another aspect provides an image data retrieval apparatus for retrieving desired image data from an image database having a plurality of items of image data registered therein, including: an image obtainer for obtaining information corresponding to an image; a table for having recorded therein the information and an image serving as a retrieval key, correlated with each other; a converter for referring to the table to convert the information to a retrieval key image; and a retriever for using the retrieval key image to retrieve from the image database image data containing an image identical or analogous to the retrieval key image.

Information corresponding to an image and an image serving as a retrieval key can be correlated and thus recorded in a table, which can be referred to to retrieve image data including an image identical or analogous to a retrieval key image. Thus an image serving as a retrieval key can readily be designated and an input operation can thus be less cumbersome.

Thus, by appropriately designating information corresponding to an image serving as a retrieval key, a user input operation can be alleviated and the image data retrieval apparatus can thus provide excellent usability.

Preferably, the information obtainer obtains more than one item of information. More than one item of information are designated and based on to retrieve image data. Thus, AND search and OR search can be provided to allow a more flexible search reflecting the user's intention.

The present invention in still another aspect provides an image data retrieval program to retrieve desired image data from an image database having a plurality of items of image data registered therein, the program causing a computer to effect the steps of: referring to the plurality of items of image data registered in the image database, and extracting an image of a predetermined region included in the image data; designating the extracted image of the predetermined region as an image serving as a retrieval key; and using the designated retrieval key image to retrieve from the image database image data containing an image identical or analogous to the retrieval key image.

From image data registered in an image database an image of a predetermined region included in the image data is extracted and designated as a retrieval key. Thus the retrieval key can readily be designated and an input operation can thus be less cumbersome in the program.

The foregoing and other objects, features, aspects and advantages of the present invention will become more apparent from the following detailed description of the present invention when taken in conjunction with the accompanying drawings.

### BRIEF DESCRIPTION OF THE DRAWINGS

In the drawings:

FIG. 1 is a block diagram schematically showing a general configuration of an image data retrieval apparatus in a first embodiment of the present invention;

FIG. 2 is a flow chart of a general process in the image data retrieval apparatus;

FIG. 3 is a flow chart specifically representing the FIG. 2 retrieval process;

FIG. 4 shows by way of example a condition window displayed on a screen in a process displaying a condition window of FIG. 3;

FIG. 5 is a flow chart of a process for designating a key face in the FIG. 3 face search process;

FIG. 6 illustrates how a key face is designated by drag and drop;

FIG. 7 is a flow chart specifically illustrating the FIG. 3 face search process;

FIG. 8 is a flow chart specifically illustrating a registration process provided by the image data retrieval apparatus in a second embodiment of the present invention;

FIG. 9 shows by way of example a window displayed on a screen in a process displaying a condition window of FIG. 3, as provided in the second embodiment;

FIG. 10 is a flow chart specifically illustrating the FIG. 3 face search process in the second embodiment;

FIG. 11 represents a concept for illustrating a general process in the image data retrieval apparatus of the second embodiment;

FIG. 12 is a flow chart specifically illustrating a registration process in the image data retrieval apparatus in a third embodiment of the present invention;

FIG. 13 is a flow chart specifically illustrating the FIG. 3 face search process in the third embodiment;

FIG. 14 represents a concept for illustrating a general process in the image data retrieval apparatus of the third embodiment;

FIG. 15 illustrates exemplary registration of a face dictionary of FIG. 14;

FIG. 16 is a flow chart specifically illustrating a registration process provided by the image data retrieval apparatus in a fourth embodiment of the present invention;

FIG. 17 is a flow chart specifically illustrating the FIG. 3 face search process in the fourth embodiment;

FIG. 18 represents a concept for illustrating a general process in the image data retrieval apparatus of the fourth embodiment; and

FIG. 19 illustrates exemplary registration of a face dictionary of FIG. 18.

### DESCRIPTION OF THE PREFERRED EMBODIMENTS

Hereinafter the present invention in embodiments will now be described more specifically with reference to the drawings.

First Embodiment

With reference to FIG. 1, an image data retrieval apparatus 100 includes an input unit 101 used for example to input data of an image taken with a digital camera and input a keyword, a key image to be retrieved and the like, an image database (DB) 105 having a plurality of items of face image data registered therein, a controller 103 effecting registration, retrieval and other processes, and a display unit 107 displaying a selection menu for input, retrieval results and the like.

Controller 103 includes a central processing unit (CPU) provided for effecting registration and retrieval, a random access memory (RAM) also corresponding to an operation region of the CPU, a read only memory (ROM) with a program stored therein, and other required memories. Image database 105 may be provided internal to image data retrieval apparatus 100, as shown in the figure, or it may be an external database connectable for example via a network.

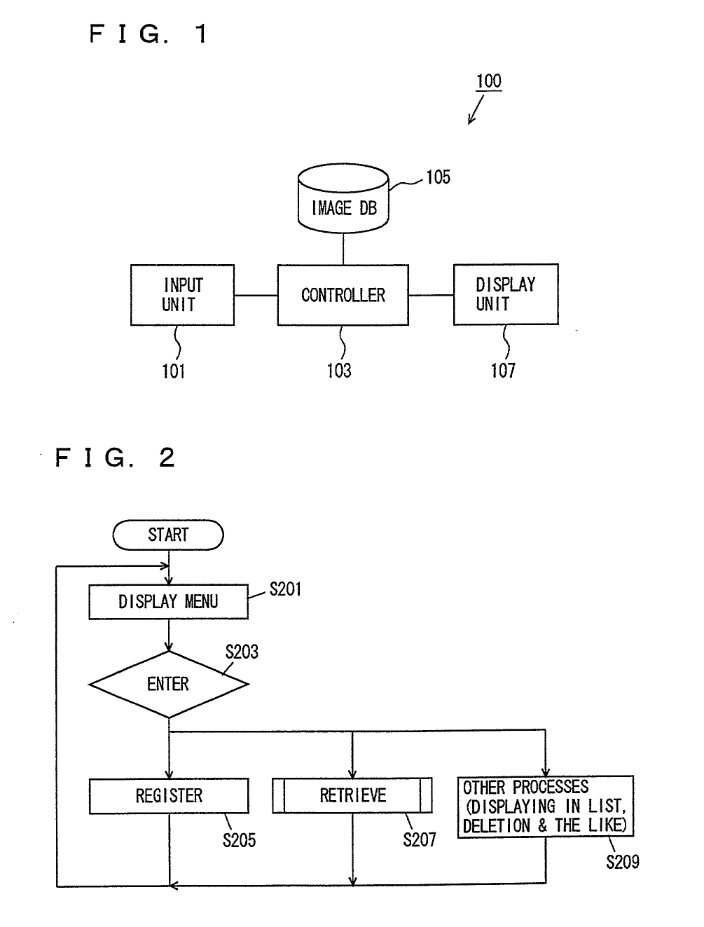

FIG. 2 is a flow chart of a general process in the FIG. 1 apparatus 100. Initially at step S201 a main menu is displayed on display unit 107. The main menu displays a variety of items, such as an image data registration process, an image data retrieval process and other processes, including listing, deletion and the like. In accordance with the displayed main menu the user inputs instructions at step S203 to effect a process, as desired.

If the user selects the image data registration process then at step S205 a process is effected to register in image database 105 data of an image for example taken with a digital camera. If the image data retrieval process is selected then at step S207 an object image (a key face) is used to effect a predetermined image data retrieval process. If any other process is selected then at step S209 a process corresponding thereto, such as listing, deletion or the like is effected.

When such selected processes end, the program returns to step S201.

In the S205 registration process a file of an image to be registered is referenced and the date of the creation of the file is obtained as date information. The date information is correlated with the image and thus registered in image database 105. The user can also input a keyword for the image. If the keyword is input it is also correlated with the image and thus registered.

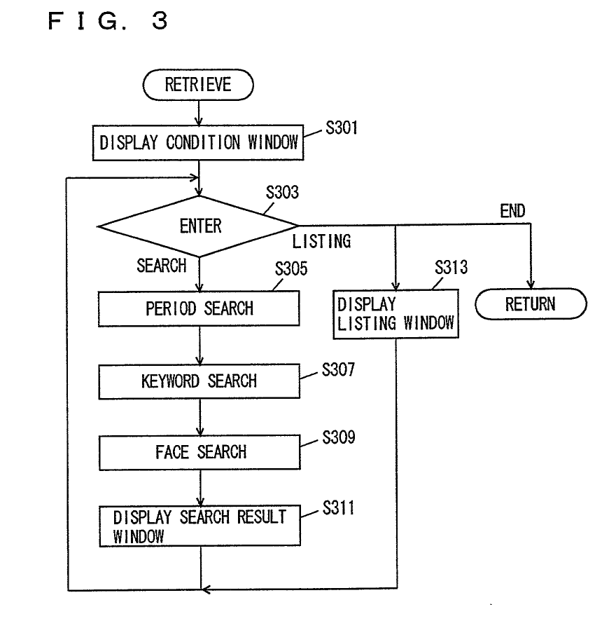

FIG. 3 is a flow chart more specifically illustrating the FIG. 2 retrieval process (step S207). As shown in the figure, initially at step S301 a condition window is displayed for setting a retrieval condition.

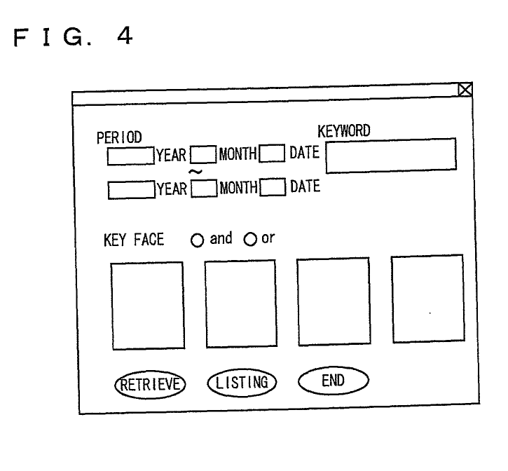

FIG. 4 shows by way of example the condition window displayed. As shown in the figure, the user can input a temporal period to be searched through, a keyword and a key image on the window. The user can designate more than one key image and also designate AND search or OR search for the images. Under the key images are displayed keys “retrieve”, “list” and “end” selectable by the user.

Again with reference to FIG. 3 if the user selects key “list” then at step S313 a listing window displays images registered in image database 105. The user refers to the images in the window and thus designates a key image serving as a retrieval key. The key image is designated, as described hereinafter more specifically.

After the listing window is displayed, the program returns to step S303. In the condition window a temporal period, a keyword and a key image are input and if key “retrieve” is selected (“retrieve” at step S303) then at step S305 a period search is conducted for the designated period.

Then at S307 the result of the period search is searched through with a keyword. At step S309, the result of the keyword search is subjected to a face search using a key face.

Thus the period search, the keyword search and the key face search are effected in AND search. A result extracted through a previous search is subjected to a subsequent search. Thus from previous retrievals successively subjects to be retrieved are narrowed down. Herein, the key face search process, which is the most time-consuming process, is effected as a final process and thus searches through the most narrowed-down subjects. Thus the key face search can complete in a reduced period of time to generally improve search efficiency.

A final result obtained through the key face search is displayed at step S311 on a window. The search result window displayed herein is a window different from the condition window.

When a search result is displayed on the window the program returns to step S303. Then with reference to the displayed search result if required an entry is again provided to conduct a search and steps S305 through S311 are repeated.

At step S303 if the user desires to terminate a search the user clicks key “end” on the displayed condition window. Thus the face image search process ends and the program returns to a main routine.

Note that if any of the search period, keyword and key face entries contains a blank then the search for the blank item is skipped. For example, if any keyword is not entered, the keyword search (step S307) is not effected. Thus the result of the period search (step S305) is subjected to the face search (step S309) and the result of the face search is displayed on a window as a final search result (step S311).

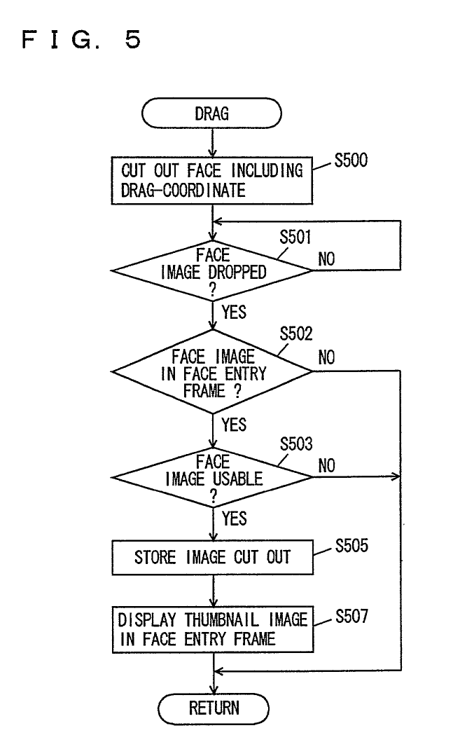

FIG. 5 is a flow chart of a process provided in the FIG. 3 face search process (step S309) to designate a key face. This process is effected while the FIG. 4 condition window is displayed and furthermore a window listing images stored in image database 105 or a search result window displaying a result of a search process is also displayed as another window.

Initially a user positions a mouse pointer on the face of a person appearing in an image displayed on the listing window or the such result window and thus drags the mouse pointer. In response at step S500 a face image is cut out. This face image contains a drag coordinate indicating a position of the image designated and dragged with the mouse pointer.

If the face image cut out is dropped (YES at step S501) in a face entry frame (YES at step S502) then the program moves on to step S503 and if not in the frame (NO at step S502) then the program returns. At step S503 a decision is made as to whether the face image cut out can be used. More specifically, a decision that an image cut out cannot be used is made for example if the image is not a face or it is a face too small to allow a search to be conducted with sufficient precision.

If the face image cut out can be used (YES at step S503) then at step S505 it is stored as a key face. Then at step S507 it is displayed in the FIG. 4 key face entry frame in the form of a thumbnail image.

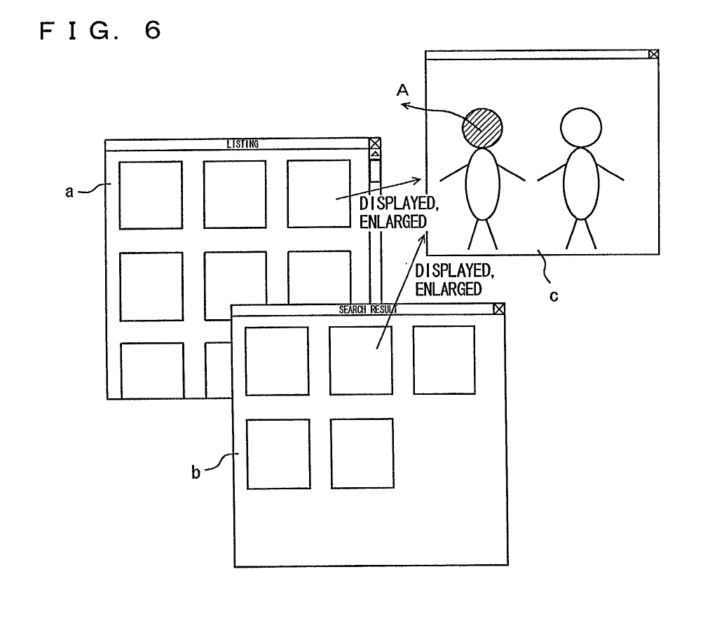

FIG. 6 illustrates how a key face is designated by drag and drop. With reference to the figure, among images displayed in a listing window a or a search result window b an image containing a desired person is double-clicked and the image is responsively enlarged and thus displayed.

When a mouse pointer is positioned on the face of the person in the enlarged image c and it is thus dragged an analysis based on the dragged position is provided on a pixel located in a vicinity thereof and a face image is cut out. The face image cut out is dragged to a key face entry frame displayed in the FIG. 4 condition window and it is dropped in the frame. Thus the key face is input in the frame.

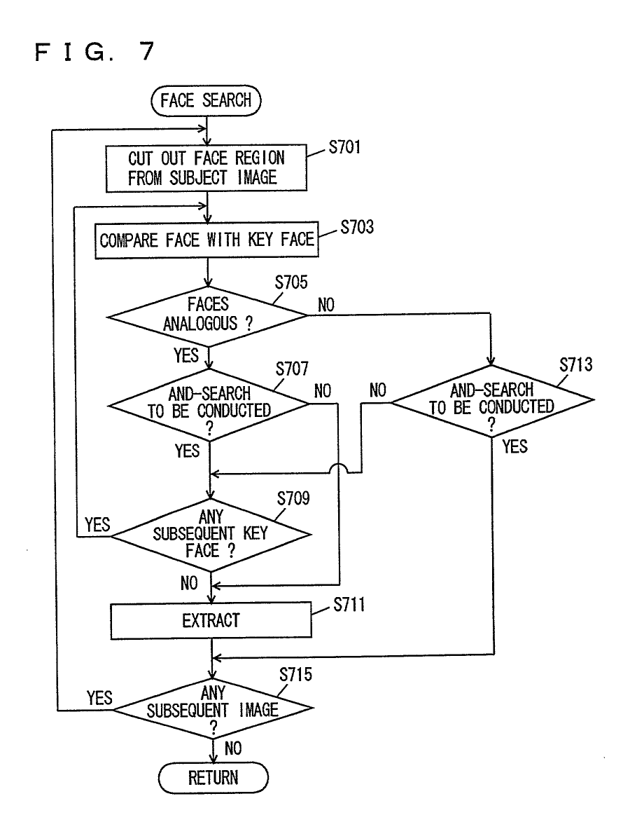

FIG. 7 is a flow chart more specifically representing the FIG. 3 face search process (step S309). With reference to FIG. 7, initially at step S701 a face region is cut out from an image stored in image database 105 that is to be searched through. If more than one face are included, all of the faces are cut out.

Then at step S703 each face image cut out is compared with the key face input in the condition window.

As a result if a decision is made that there does not exist any face image analogous to the key face (NO at step S705) then the program moves on to step S713 and if a decision is made that a face analogous thereto exists (YES at step S705) then the program moves on to step S707. Note that the term “analogous” used herein also means “identical”.

At step S713 a decision is made as to whether the key face search is AND search. More specifically, a decision is made as to which one of AND and OR searches has been designated in providing an entry in the FIG. 4 condition window.

If the key face search is AND search (YES at step S713) then a decision is made that the current subject image is not an image to be extracted and the program moves onto step S715. Then a decision is made as to whether any subsequent image exists. If the key face search is not AND search (NO at step S713) then the program moves on to step S709.

Also at step S707 a decision is made as to whether the key face search is AND search. If not (NO at step S707) then at step S711 a decision is made that the current subject image is a desired image and it is extracted.

If the key face search is AND search (YES at step S707) then a decision is made at step S709 as to whether there exists any subsequent key face serving as a retrieval key and if so then the program returns to step S703 and compares the subsequent key face with each face image cut out from an subject image to determine whether there exists an image analogous thereto (step S705).

Thus if a key face search is AND search and all key faces designated are analogous to any one of face images cut out from subject images then the subject image is extracted as a desired image. If the key face search is OR search and one or more of designated key faces is/are analogous to a face image cut out from a subject image then the subject image is extracted as a desired image.

Then at step S715 a decision is made as to whether there exists any subsequent image to be searched through. If so then the program returns to step S701 and the aforementioned process is repeated (from steps S701 through S715). If there is no subsequent image then the face search process ends and the program returns to the FIG. 3 process (step S310).

Thus in image data retrieval apparatus 100 of the present embodiment images registered in image database 105 can be referred to to designate a key face to be served as a retrieval key. Thus, entering a keyword is no longer an essential operation and an entry operation can thus be less cumbersome. Furthermore, the key face can be designated simply by dragging and dropping a desired face appearing in image data.

For example if a user desires to see an image obtained when the user had a travel with Mr. A, the user can designate an image of the face of Mr. A as a key image to appropriately extract an image with Mr. A from a large amount of stored image data.

Furthermore the selection of AND search/OR search allows the user to more flexibly retrieve a desired image. For example if the user desires to retrieve an image including both Mr. A and Ms. B then the user can designate each of them as a key face and select AND search to retrieve a desired image. If the user desires to retrieve an image including either one of Mr. A and Ms. B then the user can designate each of them as a key face and select OR search to retrieve a desired image.

Second Embodiment

Description will now be provided of an image data retrieval apparatus 200 in a second embodiment of the present invention. Image data retrieval apparatus 200 is similar in general configuration to the FIG. 1 image data retrieval apparatus 100. Its general process flow is also similar to the FIG. 2 flow chart, except for the image data registration process (step S205) and retrieval process (step S207), as will be described hereinafter more specifically.

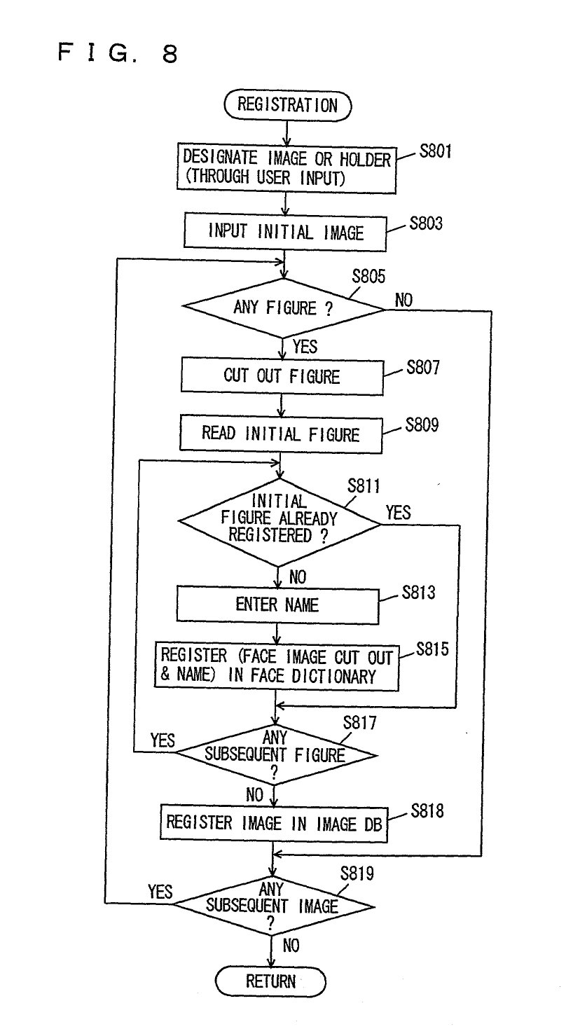

FIG. 8 is a flow chart specifically illustrating a registration process (step S205) provided by image data retrieval apparatus 200. With reference to the figure at step S801 a user designates an image or holder to be registered. In accordance with the designation a first image is input at step S803.

At step S805 a decision is made as to whether the input image includes any figure of a person. If so then at step S807 all figures in the image have their respective face images cut out. Then at step S809 an image of the face of a first person is read and at step S811 a decision is made as to whether the face image has already been registered in a face dictionary.

If not then at step S813 a name is entered to correspond to the face image. Then at step S815 the face image cut out and the entered name are correlated with each other and thus registered in the face dictionary. If the face image has already been registered then the program skips these steps and moves on to step S817.

When the registration in the face dictionary ends, a decision is made at step S817 as to whether there exists any subsequent person to be registered. If so then the program returns to step S811 and repeats the above-described process (from steps S811 through S817).

When all of the persons in the image have been registered in the face dictionary (from steps S811 through S817) (NO at step S817) then the program moves on to step S818 and the current subject image is registered in image database 105. Note that the S818 registration step is similar to that of image retrieval apparatus 100 and will thus not be described.

Then at step S819 a decision is made as to whether there is any subsequent image to be registered. If so then the program returns to step S805 to repeat a similar process (from steps S805 through S819). When there is no longer any image to be registered (NO at step S819) the registration process ends and the program returns to a main routine.

Thus, in the present embodiment, to register in image database 105 data of an image including a figure of a person the user can correlate an image of the person with a name and thus register them in a face dictionary. Note that the face dictionary may be provided internal to image database 100 or it may be provided separately.

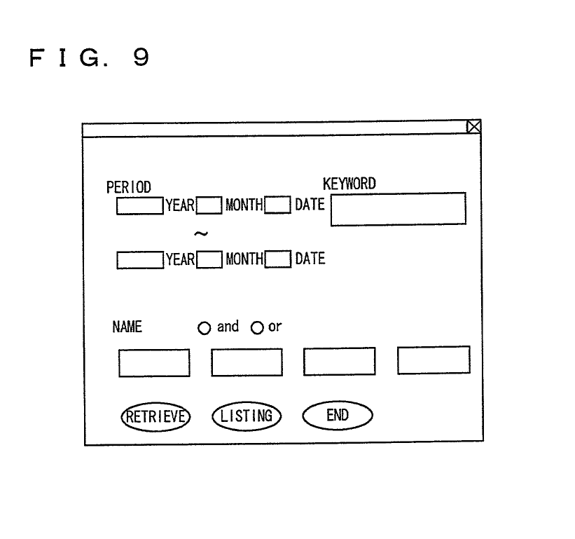

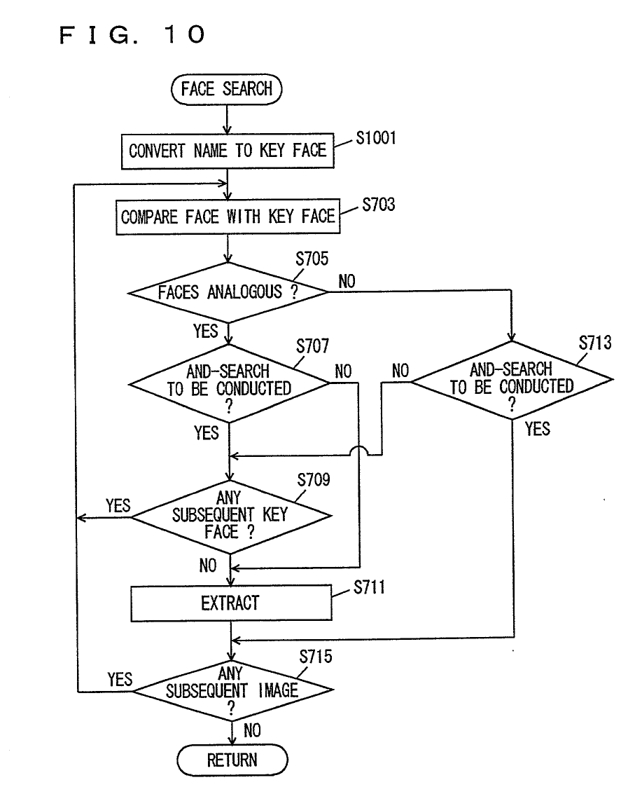

FIG. 9 shows an example of a window displayed on a screen in the FIG. 3 condition window display process (step S301) in the second embodiment. As shown in the figure, a user can enter a search period, a keyword and a name of a person to be retrieved. Thus the condition window of the second embodiment is different from that of the first embodiment in that rather than a key face, a name to be retrieved can be entered.

When a name is entered in this window and key “retrieve” is clicked, the FIG. 3 step S305-S311 search process is effected. Herein, the period search process based on a designated period (step S305) and the keyword search process based on an entered keyword (step S307) are similar to those of the first embodiment, although the face search process (step S309) has contents slightly different.

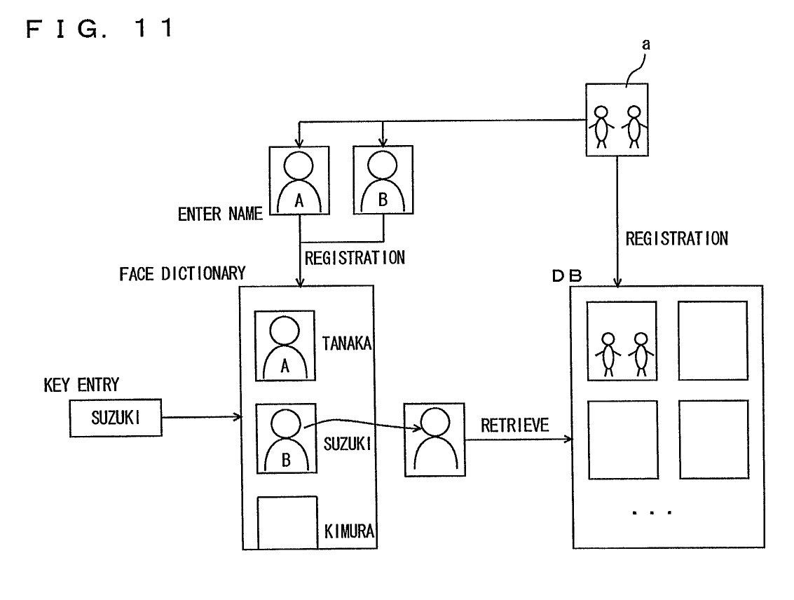

FIG. 10 is a flow chart specifically representing the FIG. 3 face search process (step S307). With reference to FIG. 10, the face search process starts and at step S1001 a name of a person to be retrieved that has been entered in the condition window is converted to a key face corresponding thereto. More specifically, a face dictionary created in registration is referred to to read a key face corresponding to the designated name.

Once a key face to be searched for is read, a subsequent process identical to the FIG. 7 process is effected (from steps S703 through S715).

Thus when a name of a person to be retrieved is designated a face dictionary is automatically referred to and the name is converted to a key face of a person corresponding thereto. The key face is then used to conduct an image search. Thus to conduct a search the user is only required to enter a desired name and this helps the user to readily conduct a search.

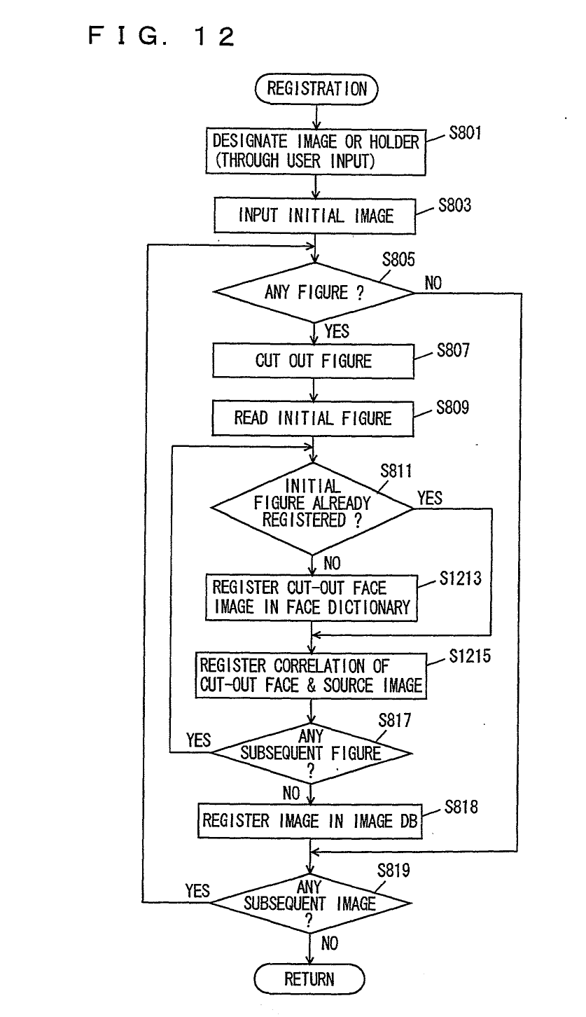

FIG. 11 shows a concept for illustrating a general process provided by image data retrieval apparatus 200. With reference to the figure, when image data is registered in image database 105 an image of a person is cut out from image a to be registered and serves as a key face. In this figure two persons A and B are shown in an image and their images are each cut out as a key face and registered in a face dictionary.

In doing so, their key faces are correlated with their respective, individual names and thus registered. Herein by way of example for the key face of Mr. A a name “Tanaka” is registered and for that of Ms. B a name “Suzuki” is registered.

If a user desires to retrieve an image including Ms. Suzuki, the user enters the name “Suzuki” on a keypad. The entered name is converted to a key face with reference to the face dictionary. The key face B is used to extract from image database 105 an image including the key face.

Thus in the present embodiment a key face and a name for the key face can previously be correlated with each other and thus registered in a face dictionary. Thus the user is not required to designate the key face and is only required to enter the name of the person. The entered name is automatically converted to a key face corresponding thereto which is in turn based on to effect a database search process. This can further alleviate a cumbersome operation otherwise provided by the user in entering data in order to conduct a search.

Third Embodiment

The present invention in a third embodiment provides an image data retrieval apparatus 300, as described hereinafter. Image data retrieval apparatus 300 is also similar in general configuration to image data retrieval apparatus 100 of the first embodiment shown in FIG. 1 and its general process flow is also similar to the FIG. 2 flow chart, although the image data registration process (step S205) and retrieval process (step S207) are slightly different in details, as described hereinafter.

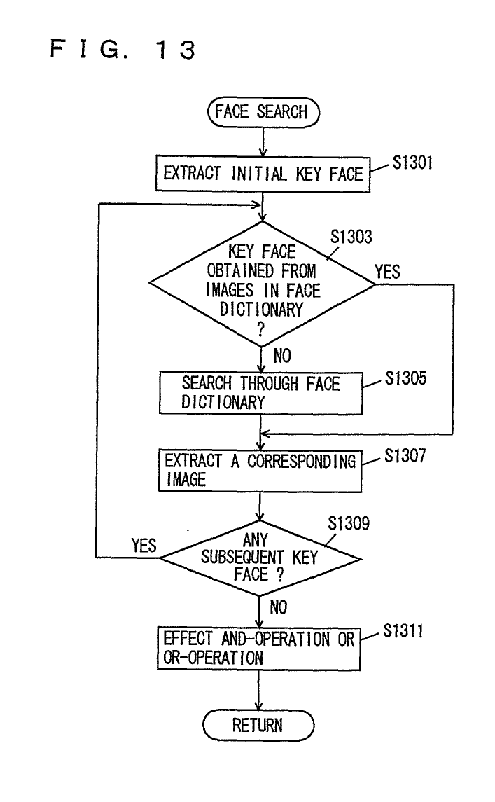

FIG. 12 is a flow chart specifically representing the registration process (step S205) provided by image data retrieval apparatus 300. The registration process described herein is substantially the same as that provided by image data retrieval apparatus 200 of the second embodiment shown in FIG. 8, except that steps S1213 and S1215 are different from the FIG. 8 process.

More specifically, if an image to be registered bears a figure of a person who has not yet been registered in a face dictionary then at step S1213 his/her face image cut out is initially registered in the face dictionary. Then at step S1215 the face image cut out and information specifying the image to be registered in image database 105, e.g., a file name are correlated with each other and thus registered. The information specifying the image to be registered may be other than a file name of the image, such as information indicating where it is stored.

Note that if a face image cut out from image data has already been registered then a process registering the face image in the face dictionary (step S1213) is skipped and the S1215 registration process is effected. More specifically, a face image cut out that has already been registered and the information specifying the image are correlated with each other and thus registered in the face dictionary.

The remaining process is similar to FIG. 8.

In the process as described above, a face image cut out and the information specifying image data including the face image are correlated with each other and thus registered in a face dictionary. As such when a face image to be retrieved is designated as a key image the registered face dictionary can be referred to to help the user to extract an image to be retrieved. This can reduce the process time for retrieval and also improve search efficiency.

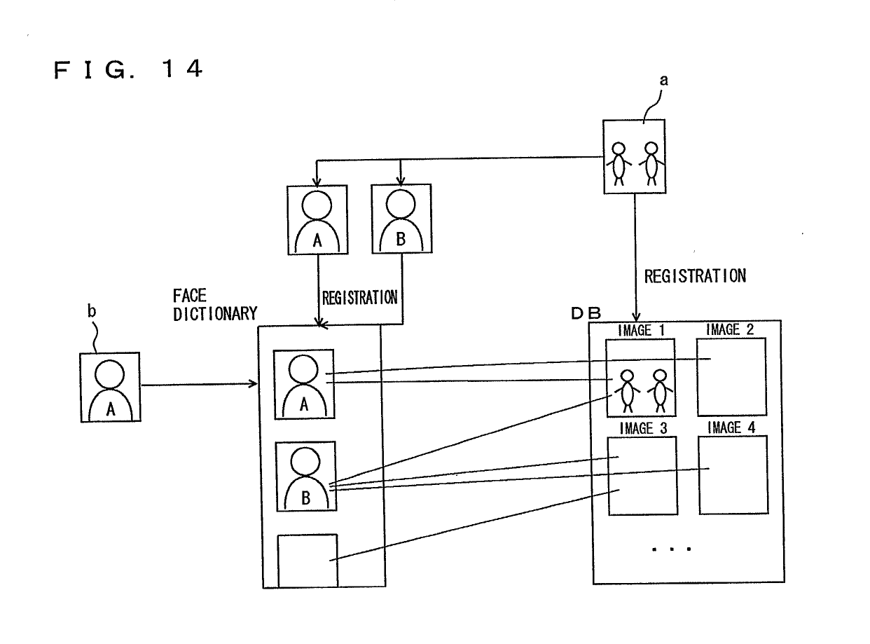

FIG. 13 is a flow chart more specifically representing the FIG. 3 face search process (step S307) in the third embodiment. Note that in the present embodiment a condition window displayed at the FIG. 3 step S301 is similar to the example shown in FIG. 4, although to designate a key image a face image registered in a face dictionary can be referenced.

With reference to FIG. 13 at step S1301 an initial key face is extracted and responsively at step S1303 a decision is made as to whether the key face is an image designated with reference to a face image registered in the face dictionary.

If not, then at step S1305 the face dictionary is searched through for a face image corresponding to the key face. At step S1307, information specifying an image, correlated and registered in the face dictionary, e.g., an image file name is read and an image is extracted in image database 105 that corresponds to the file name.

At step S1303 if a designated key image is an image designated with reference to the face dictionary then the program skips step S1305 and moves on to step S1307 to effect an image extraction process.

If a correspond image is extracted from image database 105 then at step S1309 a decision is made as to whether any subsequent key face exists. If so then the program returns to step S1303 and repeats the above process (from steps S1303 through S1309).

If any subsequent key face does not exist (NO at step S1309) then the program moves on to step S1311 to AND process or OR process the extracted image. More specifically, if an AND process is selected in the condition window, then of images corresponding to each key face and extracted an image common to all of them is extracted as a final image. If an OR search is selected then all extracted images are determined to be a search result. When the AND or OR process ends, the program completes the present retrieval process and returns to a main routine.

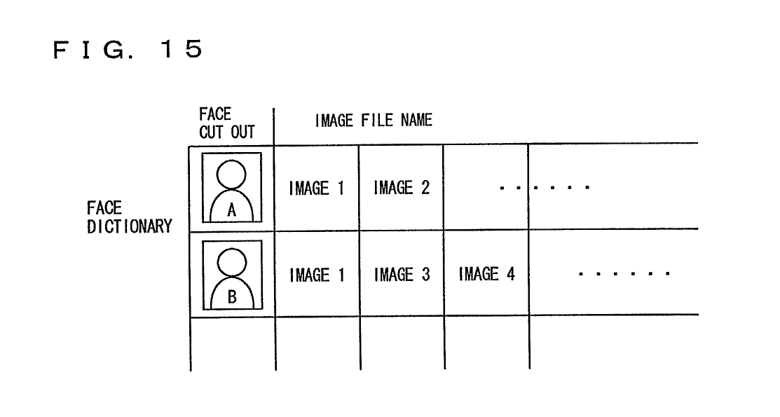

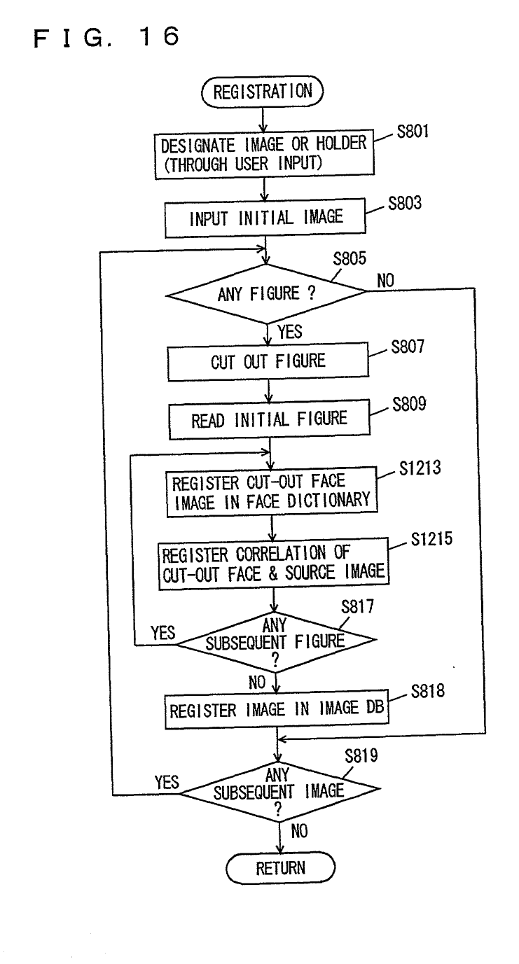

FIG. 14 shows a concept for illustrating a general process provided by image data retrieval apparatus 300. FIG. 15 shows exemplary registration in a face dictionary as shown in FIG. 14.

With reference to FIG. 14, when image data is registered in image database 105, FIGS. A and B included in image a to be registered are each cut out in the form of a face image and thus registered in the face dictionary. Then, as shown in FIG. 15, a file name of the image containing the face image cut out is recorded in the face dictionary, correlated with the face image.

For example, an image 1 bears two FIGS. A and B and a file name “image 1” is correlated to each cut-out face image and thus recorded. FIG. A also appears in an image 2 and thus in the face dictionary a file name “image 2” is also recorded as an image file name corresponding to face image A. FIG. B appears in images 1, 3 and 4 and thus in the face dictionary their respective file names “image 1”, “image 3” and “image 4” are correlated and thus recorded.

If a face image cut out has already been registered in the face dictionary then the face image cut out is not registered and a file name of the image alone is registered, correlated with a cut-out face image already registered. Thus in the face dictionary one or more image file names is/are recorded for each face image cut out.

Then in search if FIG. A is designated as a retrieval key face (image b) images cut out that are stored in the face dictionary are searched through for a face image cut out that corresponds thereto. Then an image file name correlated with the cut out face image A and registered, i.e., “image 1” and “image 2” are read. The image file names read are used to extract images 1 and 2 registered in image database 105.

Thus in the present embodiment a file name of an image including a face image is correlated with the face image and thus recorded in a face dictionary. As such in a search when a key face is designated an image including the designated key face can immediately be extracted with reference to the face dictionary. Retrieval process time can thus be reduced.

Fourth Embodiment

Finally the present invention in a fourth embodiment provides an image data retrieval apparatus 400, as described hereinafter. Image data retrieval apparatus 400 is also similar in general configuration to the FIG. 1 image data retrieval apparatus 100 and its general process flow is also similar to the FIG. 2 flow chart, except that the image data registration process (step S205) and image data retrieval process (step S207) are slightly different in details, as described hereinafter.

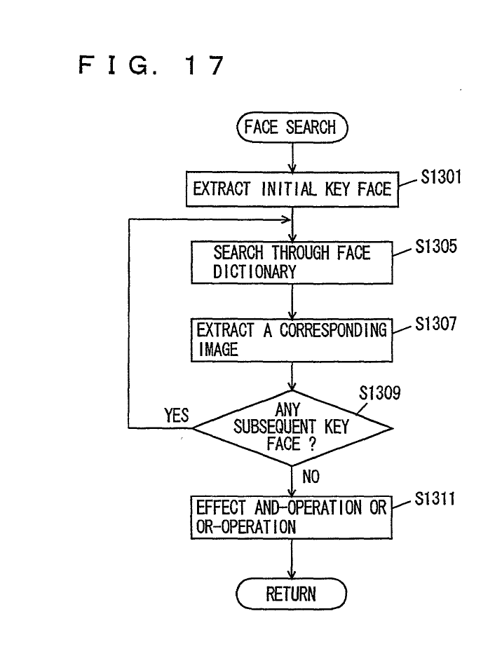

FIG. 16 is a flow chart more specifically representing the registration process (step S205) provided by image data retrieval apparatus 400. As shown in the figure, the registration process provided by image data retrieval apparatus 400 is substantially the same as that provided by the FIG. 12 image data retrieval apparatus 300.

It should be noted, however, the former is different from the latter in that the former does not provide the FIG. 12 step S811 deciding whether registration has already been effected. More specifically, the present embodiment provides a registration process registering cut-out face images successively in a face dictionary whether or not they have already been registered in the face dictionary. Then a file name of an image including the face image is correlated with the face image and thus registered.

Thus in the third embodiment whether a person of interest has already been registered in a face dictionary is determined to prevent redundant registration in the dictionary, whereas in the present embodiment a face image cut out and a file name of an image including the face image can be registered one for one and a single person may have more than one face image registered.

This process allows image data to be registered without making a decision as to whether the image includes a figure having already been registered in the face dictionary. As a result a faster registration process can be achieved.

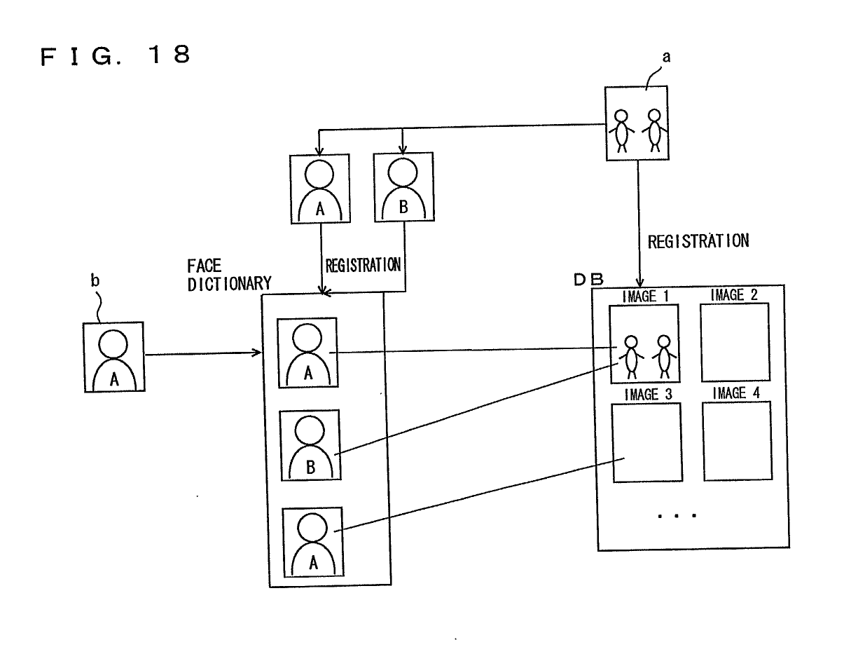

FIG. 17 is a flow chart more specifically representing the FIG. 3 face search process (step S307) in the fourth embodiment. As shown in the figure, the face search process in the present embodiment is different from that in the third embodiment shown in FIG. 13 as the former does not make a decision as to whether a designated retrieval key image is designated with reference to the face dictionary (step S1303).

This is because in the face dictionary a single person may be registered redundantly and the face dictionary displayed in the form of a list would be redundant. Thus, as shown in step S1305, a designated retrieval key face image is constantly based on to retrieve a face image stored in the face dictionary that corresponds to the key face. Then an image file name recorded that corresponds to the face image is read and image data corresponding thereto is extracted from image database 105. Note that the remaining process is similar to the FIG. 13 process.

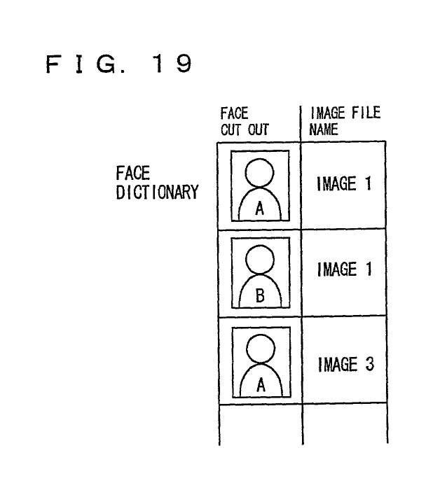

FIG. 18 shows a concept illustrating a general process provided by image data retrieval apparatus 400. FIG. 19 shows exemplary registration in the face dictionary, as shown in FIG. 18. With reference to FIGS. 18 and 19, initially in registering image data in image database 105 FIGS. A and B included in image a to be registered are each cut out in the form of a face image and thus registered in a face dictionary.

Then in the face dictionary, as shown in FIG. 19, an image file name “image 1” is correlated with each of cut-out face images A and B and thus recorded. For example, if image data “image 3” including FIG. A is registered in image database 105 then in the face dictionary a face image of FIG. A cut out and image file name “image 3” are correlated with each other and thus registered.

As such herein FIG. A have face images redundantly registered for file names “image 1” and “image 3”. Note that for each face image, a single file name of an image including the face image is recorded.

As such, if FIG. A is designated as a retrieval key face (image b) and the face dictionary is referenced, a face image cut out that corresponds to the figure is extracted. Then is read an image file name recorded that is correlated with each face image extracted. In this scenario, “image 1” and “image 3” are read. Then image data corresponding to the image file name is extracted from image database 105.

Thus in the present embodiment in additionally registering an image in image database 105 a figure included in the image can be cut out and without making a decision as to whether it has already been registered the face image and an image file name corresponding thereto can be recorded in a face dictionary. Registration process time can thus be reduced.

Image retrieval apparatuses 300, 400 of the third and fourth embodiments each allow a key face to be designated and used to effect a retrieval process. However, as in image retrieval apparatus 200 of the second embodiment, a name can also be entered and used for retrieval. In this example, correlated with a key face a respective name and information specifying an image are registered in the face dictionary.

The image retrieval method as disclosed herein can be implemented by a program provided to allow the above-described, series of process operations to function. The image data retrieval program may be installed priviously in a hard disk provided internal to the image retrieval apparatus or it may be recorded in a CD-ROM, a magnetic tape or any other similar, removable recording media. At any rate, the image data retrieval program is recorded in a computer-readable recording medium.

Note that the computer readable recording medium can for example be magnetic tape, cassette tape or any other similar type of tape, a magnetic disc (a flexible disc device, a hard disk device or the like), an optical disc (CD-ROM/MO/MD/DVD or the like) or any other similar type of disc, an IC card (including a memory card), an optical card or any other similar type of card, or ROM, EPROM, EEPROM, flush ROM or any other similar semiconductor memory medium carrying the program fixedly.

Note that while in the above the recording medium has contents stored therein in the form of a program, the contents are not limited to a program and it may be data.

The embodiments as disclosed herein use a face image of a person as an object to be searched for, since for faces and other similar complex objects it is difficult in designating a key image to create data and use it and the present retrieval method can effectively be applied. However, an object is not limited thereto and it may for example be articles, animals and plants, or any other similar objects. Furthermore, it may be geometrical figures, such as quadrangles, triangles, circles, patterns or the like.

Furthermore, in the present embodiments each image data retrieval apparatus may be adapted to operate on a server of a site managing an image management service of the Internet or it may be incorporated in digital cameras, scanners or any other similar input devices.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image data retrieval apparatus for retrieving desired image data from an image database having a plurality of items of image data registered therein, comprising:
an extractor for extracting an image of a predetermined region from said image data registered in said image database;
a retrieval key image designator for designating said extracted image as an image serving as a retrieval key; and
a retriever for using said retrieval key image to retrieve from said image database image data containing an image identical or analogous to said retrieval key image.

2. The apparatus of claim 1, wherein said image of said predetermined region is an image of a face of a person.

3. The apparatus of claim 1, wherein said designator designates more than one said retrieval key image.

4. The apparatus of claim 1, wherein said extractor extracts more than one said image of said predetermined region from said image data in said image database for storage and said designator designates a desired retrieval key image from said more than one image of said predetermined region stored.

5. The apparatus of claim 4, wherein said retriever uses said designated retrieval key image to retrieve more than one item of image data containing an image identical or analogous to said retrieval key image.

6. The apparatus of claim 4, wherein said designator designates more than one retrieval key image.

7. In order to retrieve desired image data from an image database having a plurality of items of image data registered therein, an image data retrieval program causing a computer to effect the steps of:
referring to said plurality of items of image data registered in said image database, and extracting an image of a predetermined region included in said image data;
designating said extracted image of said predetermined region as an image serving as a retrieval key; and
using said designated retrieval key image to retrieve from said image database image data containing an image identical or analogous to said retrieval key image.

8. An image data retrieval apparatus for retrieving desired image data from an image database having a plurality of items of image data registered therein, comprising;
a retrieval key image extractor for extracting images serving as a retrieval key for search through said plurality of items of image data registered in said image database;
a storage for storing said extracted retrieval key images therein;
a retrieval key image designator for designating a desired retrieval key image among said stored retrieval key images; and
a retriever for using said designated retrieval key image to retrieve from said image database more than one item of image data containing an image identical or analogous to said retrieval key image.

9. The apparatus of claim 8, wherein said extractor extracts an image of a predetermined region included in said image data registered.

10. The apparatus of claim 9, wherein said image of said predetermined region is an image of a face of a person.

11. In order to retrieve desired image data from an image database having a plurality of items of image data registered therein, an image data retrieval program causing a computer to effect the steps of:
extracting an image serving as a retrieval key for search through said plurality of items of image data registered in said image database;
storing in a storage more than one said retrieval key image extracted;
designating a desired retrieval key image among said more than one retrieval key image stored; and
using said designated retrieval key image to retrieve from said image database more than one item of image data containing an image identical or analogous to said retrieval key image.

12. An image data retrieval apparatus for retrieving desired image data from an image database having a plurality of items of image data registered therein, comprising;
a retrieval key image extractor for extracting an image serving as a retrieval key for search through said plurality of items of image data registered in said image database;
a storage for storing more than one said extracted retrieval key image therein;
a retrieval key image designator for designating more than one desired retrieval key image among said more than one retrieval key image stored; and
a retriever for using said more than one designated retrieval key image to retrieve from said image database image data containing an image identical or analogous to said retrieval key image.

13. The apparatus of claim 12, wherein said extractor extracts an image of a predetermined region included in said image data registered.

14. The apparatus of claim 13, wherein said image of said predetermined region is an image of a face of a person.

15. In order to retrieve desired image data from an image database having a plurality of items of image data registered therein, an image data retrieval program causing a computer to effect the steps of:
extracting an image serving as a retrieval key for search through said plurality of items of image data registered in said image database;
storing in a storage more than one said retrieval key image extracted;
designating more than one desired retrieval key image among said more than one retrieval key image stored in said storage; and
using said more than one designated retrieval key image to retrieve from said image database image data containing an image identical or analogous to said retrieval key image.

16. An image data retrieval apparatus for retrieving desired image data from an image database having a plurality of items of image data registered therein, comprising:
an image obtainer for obtaining information corresponding to an image;
a table for having recorded therein said information and an image serving as a retrieval key, correlated with each other;
a converter for referring to said table to convert said information to a retrieval key image; and
a retriever for using said retrieval key image to retrieve from said image database image data containing an image identical or analogous to said retrieval key image.

17. The apparatus of claim 16, wherein said information obtainer obtains more than one item of information.

18. The apparatus of claim 16, wherein said image of said predetermined region is an image of a face of a person.

19. The apparatus of claim 18, wherein said obtainer obtains information in a form of a name of a person.

20. In order to retrieve desired image data from an image database having a plurality of items of image data registered therein, an image data retrieval program causing a computer to effect the steps of:
obtaining information corresponding to an image;
converting said information to a retrieval key image with reference to a table having recorded therein said information and an image serving as a retrieval key, correlated with each other; and
using said retrieval key image to retrieve from said image database image data including an image identical or analogous to said retrieval key image.
